(19) United States
(12) Patent Application Publication
(10) Pub. No.: US 2026/0227544 A1
(43) Pub. Date: Aug. 6, 2026

(54) METHODS AND SYSTEMS FOR IDENTIFYING A ZONE OF INTEREST IN A WELLBORE

(71) Applicant: Hifi Engineering Inc., Calgary (CA)

(72) Inventors: Seyed Ehsan JALILIAN, Calgary (CA); Tasnim HOSSAIN, Calgary (CA)

(21) Appl. No.: 19/148,176

(22) PCT Filed: Jan. 11, 2024
(86) PCT No.: PCT/CA2024/050032

§ 371 Date: Jul. 15, 2025

Related U.S. Application Data
(60) Provisional application No. 63/439,239, filed on Jan. 16, 2023.

(51) Int. Cl. G01V 11/00; E21B 47/07; E21B 49/00

(52) U.S. Cl. CPC G01V 11/002; E21B 47/07; E21B 49/00

(57) ABSTRACT

A method of identifying a zone of interest in a wellbore is described. The method includes performing by one or more computer processors at least some of the following steps. Production data comprising data relating to surface production from the wellbore is obtained. Parameter data comprising data relating to one or more parameters of the wellbore as a function of depth along the wellbore is obtained. Cross-correlation data is generated by cross-correlating the production data with the parameter data. The cross-correlation data comprises data relating to cross-correlation strength as a function of the depth along the wellbore. One or more zones of interest are identified within the cross-correlation data, based on the cross-correlation strength and the depth along the wellbore.

### FIELD

The present disclosure relates to downhole production of oil and gas, and in particular to methods and systems for identifying a zone of interest in a wellbore.

### BACKGROUND

During downhole production operations through a subterranean formation, materials (such as oil, gas, water, and/or condensate) that are produced downhole are pumped to the surface. While the flowrates of such products are able to be monitored at the surface, it is difficult to identify the particular zones within the subterranean formation that led to the generation of the products. For instance, in some subterranean formations, oil and/or gas deposits may be most prevalent only at certain depths, as the deposits may extend more in the horizontal that in the vertical.

For this reason, oil and gas companies often seek to identify ways which the production rates at the surface may be linked to specific zones through which the wellbore extends.

### SUMMARY

According to a first aspect of the disclosure, there is provided a method of identifying a zone of interest in a wellbore. The method comprises: performing by one or more computer processors: obtaining production data comprising data relating to surface production from the wellbore; obtaining parameter data comprising data relating to one or more parameters of the wellbore as a function of depth along the wellbore; and generating cross-correlation data by cross-correlating the production data with the parameter data, wherein the cross-correlation data comprises data relating to cross-correlation strength as a function of the depth along the wellbore; and identifying within the cross-correlation data one or more zones of interest, based on the cross-correlation strength and the depth along the wellbore.

Obtaining the parameter data may comprise generating the parameter data by: using one or more sensors positioned along the wellbore to monitor the one or more parameters; and generating the parameter data based on the monitored one or more parameters.

The one or more sensors may comprise one or more lengths of optical fiber. Generating the parameter data may comprise interrogating the one or more lengths of optical fiber using an optical fiber interrogator configured to transmit one or more light pulses along the one or more lengths of optical fiber and detect reflections of the one or more light pulses.

The one or more lengths of optical fiber may comprise one or more fiber Bragg gratings for reflecting the one or more lights pulses transmitted by the optical fiber interrogator.

Generating the parameter data may comprise: generating interferometric data by interrogating the one or more lengths of optical fiber using the optical fiber interrogator; and extracting the parameter data by processing the interferometric data.

Extracting the parameter data may comprise extracting acoustic data in a frequency range of 10 Hz-100,000 Hz from the interferometric data.

Extracting the data may comprise extracting differential temperature or strain data in a frequency range of 0.001 Hz-10 Hz from the interferometric data.

The one or more parameters may comprise one or more of: acoustics originating from the wellbore; and differential temperature experienced by a sensor used to monitor the wellbore.

Obtaining the parameter data may comprise: receiving unfiltered parameter data; and performing one or more of the following on the unfiltered parameter data: filtering the unfiltered parameter data based on one or more frequency ranges; and downsampling the unfiltered parameter data based on a sampling rate of the production data.

Obtaining the parameter data may comprise generating the parameter data by interrogating optical fiber positioned alongside the wellbore, the optical fiber divided into multiple channels, each channel comprising a portion of a length of the optical fiber and being associated with a respective portion of the parameter data. Generating the cross-correlation data may comprise, for each channel, cross-correlating the production data with the portion of the parameter associated with the channel.

Identifying the one or more zones of interests may comprise: identifying in the cross-correlation data one or more regions of relatively high cross-correlation strength; and identifying the one or more zones of interests based on the one or more depths corresponding to the one or more regions of relatively high cross-correlation strength.

The method may further comprise: obtaining temperature data indicative of temperature as a function of the depth along the wellbore; and confirming, based on the temperature data, at least one zone of interest of the one or more zones of interest as a zone of interest.

Confirming the zone of interest may comprise: comparing temperature data to the cross-correlation data; and confirming, based on the comparison, the zone of interest.

Obtaining the temperature data may comprise using one or more sensors positioned along the wellbore to generate the temperature data.

According to a further aspect of the disclosure, there is provided a system for monitoring a wellbore, comprising: optical fiber positioned alongside the wellbore; an optical fiber interrogator configured to interrogate the optical fiber; and one or more computer processors configured to: control the optical fiber interrogator so as to interrogate the optical fiber; receive, based on the interrogation of the optical fiber, interferometric data from the optical fiber interrogator; extract parameter data from the interferometric data, the parameter data comprising data relating to one or more parameters of the wellbore as a function of depth along the wellbore; receive production data comprising data relating to surface production from the wellbore; and generate cross-correlation data by cross-correlating the production data with the parameter data, wherein the cross-correlation data comprises data relating to cross-correlation strength as a function of the depth along the wellbore.

According to a further aspect of the disclosure, there is provided a non-transitory, computer-readable medium having stored thereon computer program code executable by one or more processors and configured, when executed by the one or more processors, to cause the one or more processors to perform a method of identifying a zone of interest in a wellbore, the method comprising: receiving production data comprising data relating to surface production from the wellbore; receiving parameter data comprising data relating to one or more parameters of the wellbore as a function of depth along the wellbore; generating cross-correlation data by cross-correlating the production data with the parameter data, wherein the cross-correlation data comprises data relating to cross-correlation strength as a function of the depth along the wellbore; and identifying within the cross-correlation data one or more zones of interest, based on the cross-correlation strength and the depth along the wellbore.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIG. 1A is a block diagram of an optical interrogation system including an optical fiber with fiber Bragg gratings (“FBGs”) for reflecting a light pulse, in accordance with an embodiments of the disclosure;

FIG. 1B is a schematic diagram that depicts how the FBGs reflect a light pulse, in accordance with embodiments of the disclosure;

FIG. 1C is a schematic diagram that depicts how a light pulse interacts with impurities in an optical fiber that results in scattered laser light due to Rayleigh scattering, which is used for distributed acoustic sensing (“DAS”), in accordance with embodiments of the disclosure;

FIG. 2 is a schematic diagram of an optical interrogation system for identifying zones of interest in a wellbore, in accordance with embodiments of the disclosure;

FIG. 3 is a flow diagram of a method of identifying zones of interest in a wellbore, in accordance with embodiments of the disclosure;

FIG. 4 is a plot of production data and acoustic data as a function of time, according to an embodiment of the disclosure;

FIG. 5 is a plot of production data and differential temperature data as a function of time, according to an embodiment of the disclosure;

FIG. 6 is a plot of production data for condensate, water, and gas, as a function of time, according to an embodiment of the disclosure;

FIG. 7 is a plot of spectral power density of the production data in FIG. 6, according to an embodiment of the disclosure;

FIG. 8 is a plot of acoustic data with the DC offset removed, according to an embodiment of the disclosure;

FIG. 9 is a plot of the acoustic data of FIG. 8 having been passed through a band-pass filter, according to an embodiment of the disclosure;

FIG. 10 is a plot of the acoustic data of FIG. 9 after downsampling, according to an embodiment of the disclosure;

FIG. 11 is a plot of condensate flowrate as a function of time, according to an embodiment of the disclosure;

FIG. 12 is a plot of cross-correlation strength based on the acoustic data of FIG. 10 and the condensate flowrate of FIG. 11, according to an embodiment of the disclosure;

FIG. 13 is a cross-correlation map based on a cross-correlation performed for every channel of a length of optical fiber, according to an embodiment of the disclosure;

FIGS. 14A-14C show multiple cross-correlation maps based on different sets of production data and acoustic data, according to embodiments of the disclosure;

FIGS. 15A-15C show the cross-correlation maps of FIGS. 14A-14C, with lag on the x-axis, according to embodiments of the disclosure;

FIG. 16 is a plot of differential temperature data as a function of time and depth, according to an embodiment of the disclosure;

FIG. 17A is a plot of downhole temperature as a function of time, according to an embodiment of the disclosure;

FIG. 17B is a plot of strain as a function of time, according to an embodiment of the disclosure; and

FIG. 17C is a plot of differential temperature data as a function of time, based on the plot of FIG. 17B, according to an embodiment of the disclosure.

Throughout the drawings, MD refers to measured depth, and TVD refers to total vertical depth.

### DETAILED DESCRIPTION

The present disclosure seeks to provide methods and systems for identifying zones of interest in a wellbore. While various embodiments of the disclosure are described below, the disclosure is not limited to these embodiments, and variations of these embodiments may well fall within the scope of the disclosure which is to be limited only by the appended claims.

Fiber optic cables are often used as distributed measurement systems in acoustic sensing applications. Pressure changes, due to sound waves for example, in the space immediately surrounding an optical fiber and that encounter the optical fiber cause dynamic strain in the optical fiber. Optical interferometry may be used to detect the dynamic strain along a segment of the fiber. Optical interferometry is a technique in which two separate light pulses, a sensing pulse and a reference pulse, are generated and interfere with each other. The sensing and reference pulses may, for example, be directed along an optical fiber that comprises fiber Bragg gratings. The fiber Bragg gratings partially reflect the pulses back towards an optical receiver at which an interference pattern is observed.

The nature of the interference pattern observed at the optical receiver provides information on the optical path length the pulses traveled, which in turn provides information on parameters such as the strain experienced by the segment of optical fiber between the fiber Bragg gratings. Information on the strain then provides information about the event that caused the strain.

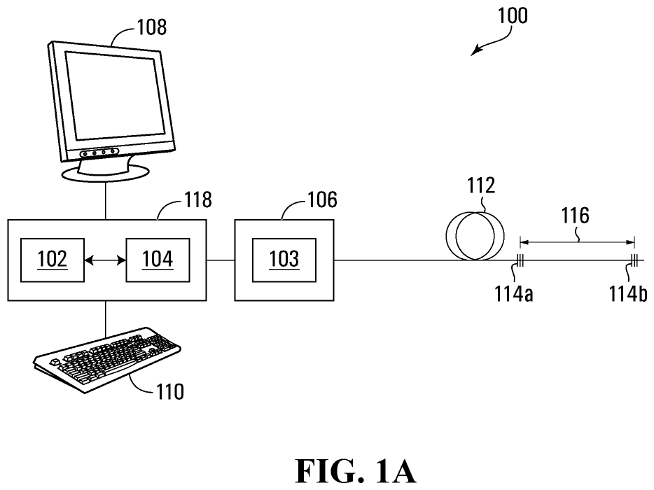

Referring now to FIG. 1A, there is shown one embodiment of a system 100 for performing interferometry using fiber Bragg gratings (“FBGs”), in accordance with embodiments of the disclosure. The system 100 comprises optical fiber 112, an interrogator 106 optically coupled to the optical fiber 112, and a signal processing device 118 that is communicative with the interrogator 106.

The optical fiber 112 comprises one or more fiber optic strands, each of which is made from quartz glass (amorphous SiO2). The fiber optic strands are doped with various elements and compounds (including germanium, erbium oxides, and others) to alter their refractive indices, although in alternative embodiments the fiber optic strands may not be doped. Single mode and multimode optical strands of fiber are commercially available from, for example, Corning® Optical Fiber. Example optical fibers include ClearCurve™ fibers (bend insensitive), SMF28 series single mode fibers such as SMF-28 ULL fibers or SMF-28e fibers, and InfmiCor® series multimode fibers.

The interrogator 106 generates the sensing and reference pulses and outputs the reference pulse after the sensing pulse. The pulses are transmitted along optical fiber 112 that comprises a first pair of FBGs. The first pair of FBGs comprises first and second FBGs 114a,b (generally, “FBGs 114”). The first and second FBGs 114a,b are separated by a certain segment 116 of the optical fiber 112 (“fiber segment 116”). The optical length of the fiber segment 116 varies in response to dynamic strain that the fiber segment 116 experiences.

The light pulses have a wavelength identical or very close to the center wavelength of the FBGs 114, which is the wavelength of light the FBGs 114 are designed to partially reflect; for example, typical FBGs 114 are tuned to reflect light in the 1,000 to 2,000 nm wavelength range. The sensing and reference pulses are accordingly each partially reflected by the FBGs 114a,b and return to the interrogator 106. The delay between transmission of the sensing and reference pulses is such that the reference pulse that reflects off the first FBG 114a (hereinafter the “reflected reference pulse”) arrives at the optical receiver 103 simultaneously with the sensing pulse that reflects off the second FBG 114b (hereinafter the “reflected sensing pulse”), which permits optical interference to occur.

While FIG. 1A shows only the one pair of FBGs 114a,b, in alternative embodiments (not depicted) any number of FBGs 114 may be on the fiber 112, and time division multiplexing (TDM) (and, optionally, wavelength division multiplexing (WDM)) may be used to simultaneously obtain measurements from them. If two or more pairs of FBGs 114 are used, any one of the pairs may be tuned to reflect a different center wavelength than any other of the pairs. Alternatively, a group of multiple FBGs 114 may be tuned to reflect a different center wavelength to another group of multiple FBGs 114, and there may be any number of groups of multiple FBGs extending along the optical fiber 112 with each group of FBGs 114 tuned to reflect a different center wavelength. In these example embodiments where different pairs or group of FBGs 114 are tuned to reflect different center wavelengths to other pairs or groups of FBGs 114, WDM may be used in order to transmit and to receive light from the different pairs or groups of FBGs 114, effectively extending the number of FBG pairs or groups that can be used in series along the optical fiber 112 by reducing the effect of optical loss that otherwise would have resulted from light reflecting from the FBGs 114 located on the fiber 112 nearer to the interrogator 106. When different pairs of the FBGs 114 are not tuned to different center wavelengths, TDM is sufficient.

The interrogator 106 emits laser light with a wavelength selected to be identical or sufficiently near the center wavelength of the FBGs 114, and each of the FBGs 114 partially reflects the light back towards the interrogator 106. The timing of the successively transmitted light pulses is such that the light pulses reflected by the first and second FBGs 114a,b interfere with each other at the interrogator 106, which records the resulting interference signal. The strain that the fiber segment 116 experiences alters the optical path length between the two FBGs 114 and thus causes a phase difference to arise between the two interfering pulses. The resultant optical power at the optical receiver 103 can be used to determine this phase difference. Consequently, the interference signal that the interrogator 106 receives varies with the strain the fiber segment 116 is experiencing, which allows the interrogator 106 to estimate the strain the fiber segment 116 experiences from the received optical power. The interrogator 106 digitizes the phase difference (“output signal”) whose magnitude and frequency vary directly with the magnitude and frequency of the dynamic strain the fiber segment 116 experiences.

The signal processing device 118 is communicatively coupled to the interrogator 106 to receive the output signal. The signal processing device 118 includes a processor 102 and a non-transitory computer-readable medium 104 that are communicatively coupled to each other. An input device 110 and a display 108 interact with control module 250. The computer-readable medium 104 has stored on it program code to cause control module 250 to perform any suitable signal processing methods to the output signal. For example, if the fiber segment 116 is laid adjacent a region of interest that is simultaneously experiencing vibration at a rate under 20 Hz and acoustics at a rate over 20 Hz, the fiber segment 116 will experience similar strain and the output signal will comprise a superposition of signals representative of that vibration and those acoustics. Control module 250 may apply to the output signal a low pass filter with a cut-off frequency of 20 Hz, to isolate the vibration portion of the output signal from the acoustics portion of the output signal. Analogously, to isolate the acoustics portion of the output signal from the vibration portion, control module 250 may apply a high-pass filter with a cut-off frequency of 20 Hz. Control module 250 may also apply more complex signal processing methods to the output signal; example methods include those described in PCT application PCT/CA2012/000018 (publication number WO 2013/102252), the entirety of which is hereby incorporated by reference.

FIG. 1B depicts how the FBGs 114 reflect the light pulse, according to another embodiment in which the optical fiber 112 comprises a third FBG 114c. In FIG. 1B, the second FBG 114b is equidistant from each of the first and third FBGs 114a,c when the fiber 112 is not strained. The light pulse is propagating along the fiber 112 and encounters three different FBGs 114, with each of the FBGs 114 reflecting a portion 115 of the pulse back towards the interrogator 106. In embodiments comprising three or more FBGs 114, the portions of the sensing and reference pulses not reflected by the first and second FBGs 114a,b can reflect off the third FBG 114c and any subsequent FBGs 114, resulting in interferometry that can be used to detect strain along the fiber 112 occurring further from the interrogator 106 than the second FBG 114b. For example, in the embodiment of FIG. 1B, a portion of the sensing pulse not reflected by the first and second FBGs 114a,b can reflect off the third FBG 114 c, and a portion of the reference pulse not reflected by the first FBG 114a can reflect off the second FBG 114b, and these reflected pulses can interfere with each other at the interrogator 106.

Any changes to the optical path length of the fiber segment 116 result in a corresponding phase difference between the reflected reference and sensing pulses at the interrogator 106. Since the two reflected pulses are received as one combined interference pulse, the phase difference between them is embedded in the combined signal. This phase information can be extracted using proper signal processing techniques, such as phase demodulation. The relationship between the optical path of the fiber segment 116 and that phase difference (⊖) is as follows:

$$⊖ = 2 π nL / λ ,$$

where n is the index of refraction of the optical fiber, L is the physical path length of the fiber segment 116, and A is the wavelength of the optical pulses. A change in nL is caused by the fiber experiencing longitudinal strain induced by energy being transferred into the fiber. The source of this energy may be, for example, an object outside of the fiber experiencing dynamic strain, undergoing vibration, or emitting energy. As used herein, “dynamic strain” refers to strain that changes over time. Dynamic strain that has a frequency of between about 5 Hz and about 20 Hz is referred to by persons skilled in the art as “vibration”, dynamic strain that has a frequency of greater than about 20 Hz is referred to by persons skilled in the art as “acoustics”, and dynamic strain that changes at a rate of <1 Hz, such as at 500 μHz, is referred to as “sub-Hz strain”.

One conventional way of determining ΔnL is by using what is broadly referred to as distributed acoustic sensing (“DAS”). DAS involves laying the fiber 112 through or near a region of interest and then sending a coherent laser pulse along the fiber 112. As shown in FIG. 1C, the laser pulse interacts with impurities 113 in the fiber 112, which results in scattered laser light 117 because of Rayleigh scattering. Vibration or acoustics emanating from the region of interest results in a certain length of the fiber becoming strained, and the optical path change along that length varies directly with the magnitude of that strain. Some of the scattered laser light 117 is back-scattered along the fiber 112 and is directed towards the optical receiver 103, and depending on the amount of time required for the scattered light 117 to reach the receiver and the phase of the scattered light 117 as determined at the receiver, the location and magnitude of the vibration or acoustics can be estimated with respect to time. DAS relies on interferometry using the reflected light to estimate the strain the fiber experiences. The amount of light that is reflected is relatively low because it is a subset of the scattered light 117. Consequently, and as evidenced by comparing FIGS. 1B and 1C, Rayleigh scattering transmits less light back towards the optical receiver 103 than using the FBGs 114.

DAS accordingly uses Rayleigh scattering to estimate the magnitude, with respect to time, of the strain experienced by the fiber during an interrogation time window, which is a proxy for the magnitude of the vibration or acoustics emanating from the region of interest. In contrast, the embodiments described herein measure dynamic strain using interferometry resulting from laser light reflected by FBGs 114 that are added to the fiber 112 and that are designed to reflect significantly more of the light than is reflected as a result of Rayleigh scattering. This contrasts with an alternative use of FBGs 114 in which the center wavelengths of the FBGs 114 are monitored to detect any changes that may result to it in response to strain. In the depicted embodiments, groups of the FBGs 114 are located along the fiber 112. A typical FBG can have a reflectivity rating of between 0.1% and 5%. The use of FBG-based interferometry to measure dynamic strain offers several advantages over DAS, in terms of optical performance.

Generally, according to embodiments of the disclosure, there will now be described methods and systems for identifying zones of interest in a wellbore. A zone of interest may be, for example, a zone, such as a depth range, that is identified as generally correlating to relatively low or high production of downhole material, such as condensate, gas, oil, or water. In order to identify such zones of interest, as described above and in further detail below, optical fiber that is positioned alongside the wellbore may be interrogated, using an optical fiber interrogator, in order to generate raw interferometric data. The interrogation system may rely on point reflectors (such as FBGs) or else may rely on DAS, as described above.

The interferometric data may then be processed to extract parameter data from the interferometric data and at various depths along the wellbore. For example, the interferometric data may be processed to extract acoustic data or differential temperature data from the interferometric data. Differential temperature data may comprise data that is correlated to, or that is indicative of, changes in temperature. Acoustic data may comprise data in a frequency range from 10 Hz to 100 kHz, or more typically between 0 and 20 kHz. Differential temperature data may comprise data in a frequency range from 0.001 Hz to 10 Hz. The parameter data may then be cross-correlated with production data that describes production rates of one or more materials at the surface. When performing the cross-correlation, for each channel of the optical fiber, the parameter data generated for that channel is cross-correlated with the production data. This process may be repeated for each channel of the optical fiber. As described in further detail below, a channel may correspond to a certain length of the optical fiber, and therefore may correspond to a particular depth. Interferometric data generated as a result of operating the optical fiber interrogator may be identified as being associated with a certain channel or channels of the optical fiber, using for example TDM and/or WDM as described above. The totality of the cross-correlations performed may be used to generate a cross-correlation map which shows, for each channel of the optical fiber, the cross-correlation strength between the production data at the surface as a function of parameter data (e.g. acoustic data or differential temperature data). This cross-correlation strength may then be used to identify any zones of interest in the wellbore.

For example, based on the underlying assumption that relatively higher production generally results in stronger acoustics from the wellbore, or particular thermal signatures, channels associated with stronger acoustic data or stronger differential temperature data may be identified as corresponding to zones or regions of the wellbore that are producing more when compared to other zones or regions of the wellbore. Such data may be used by oil and gas companies, or any other interested parties, for more efficient production purposes, or for improved targeting of zones for the injection of steam or gas in order to enhance production rates. For instance, interrogation of optical fiber alongside a wellbore, and cross-correlation of the resulting data with surface production data, may reveal that a particular zone (e.g. a particular depth range) is strongly correlated to high production rates of gas or condensate. Further actions may therefore be focussed on this zone in order to increase the production of a particular product if desired (for example, oil) or to stop production of a particular product if undesired (for example, water).

According to some embodiments, instead of using optical fiber interferometry, it may be possible to correlate acoustic data to production data using other types of sensors. For example, DAS fiber, microphones, or any other suitable acoustic sensor, positioned alongside the wellbore may be used to obtain the acoustic data.

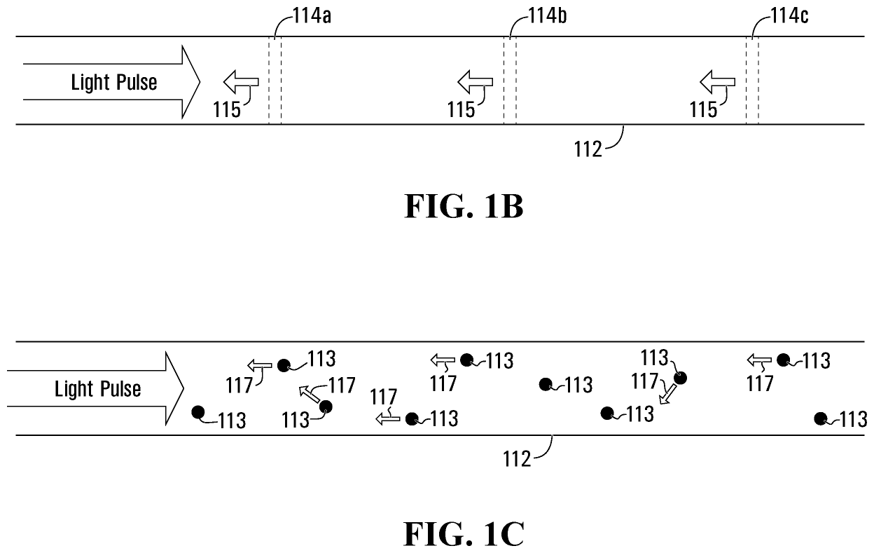

Referring now to FIG. 2, there is shown an optical interrogation system 200 (similar to system 100) that may be used to identify zones of interest in a wellbore 11, in accordance with embodiments of the disclosure. FIG. 2 shows wellbore 11 alongside of which is provided a length of optical fiber 12. For example, according to some embodiments optical fiber 12 is attached to wellbore 11. FBGs (not shown), as described above, are provided along the length of optical fiber 12 for reflecting light transmitted along optical fiber 12. In some embodiments, optical fiber 12 may comprise multiple individual interconnected lengths of optical fiber.

Optical fiber 12 is optically coupled to an interrogator 14. Interrogator 14 is configured to interrogate optical fiber 12 using optical fiber interferometry, as described above. Interrogator 14 is communicatively coupled to a control module 15. Control module 15 comprises one or more processors and one or more memories comprising computer program code executable by the one or more processors and configured, when executed by the one or more processors, to cause the one or more processors to process phase data obtained by interrogator 14 from interferences between light pulses transmitted along optical fiber 12. In some embodiments, control module 15 may be comprised within interrogator 14 such that interrogator 14 may perform the functions of control module 15.

Optical fiber 12 is divided into a number of channels or portions of optical fiber. In order to distinguish between different channels, interrogator 14 may employ techniques known in the art such as TDM or WDM, or a combination of both, as described above. For instance, in the context of WDM, different pulses having different wavelengths may be transmitted along optical fiber 12. Each channel of optical fiber 12 may be provided with FBGs configured to reflect light having a certain wavelength. Depending on the wavelength of the reflections received from optical fiber 12, interrogator 14 may determine from which channel the reflections originated.

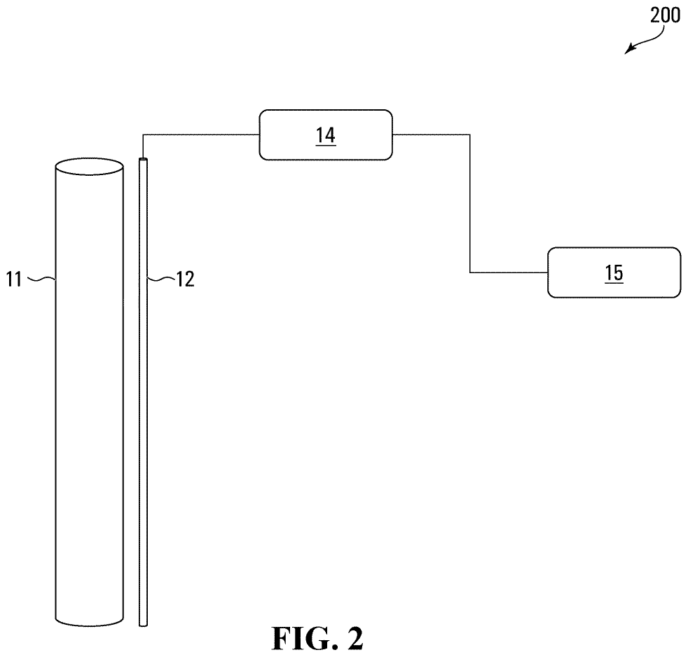

As will now be described in further detail, control module 15, interrogator 14, and optical fiber 12 are used to generate and process acoustic/differential temperature data from wellbore 11. Turning first to FIG. 3, there is shown an example method of using optical fiber interferometry to identify one or more zones of interest in wellbore 11, according to an embodiment of the disclosure.

At block 302, production data is obtained. The production data includes data relating to rates of production of one or more materials at the surface of wellbore 11, as a function of time. For example, the production data may include data relating to flowrates of one or more of water, oil, gas, and condensate at the surface of wellbore 11. According to some embodiments, the production data may be obtained after block 304, or after block 306.

At block 304, interrogator 14 captures raw interferometric data by interrogating optical fiber 12 by transmitting light pulses along optical fiber 12, and detecting reflections of the light pulses from the FBGs positioned along optical fiber 12. Differences in phase between the transmitted and reflected pulses may be due to the result of acoustic signals interfering with the transmitted and reflected pulses. The raw interferometric data may be based on phase data relating to the interferences between the transmitted and reflected pulses. Generally, the raw interferometric data includes both acoustic data and differential temperature data that can be extracted from the raw interferometric data. For example, using any suitable filter, lower-frequency data (usually <10 Hz, and representative of strain or differential temperature) may be separated from higher-frequency data.

At block 306, control module 15 processes the interferometric data to extract the acoustic data and/or differential temperature data therefrom. In addition, control module 15 preprocess the extracted data, for example by removing a vertical DC offset from the data, passing the data through one or more filters, and downsampling the data, as described in further detail below.

At block 308, for each channel of optical fiber 12, control module 15 calculates the cross-correlation of the acoustic data/differential temperature data generated for that channel with the production data obtained at block 302. For example, in the case of acoustic data, the root mean square (RMS) (or some other parameter relating to magnitude) of the acoustic data generated for that channel is cross-correlated with the production data obtained at block 302.

Based on the cross-correlations calculated at block 308, at block 310, control module 15 generates a cross-correlation map. Generating the cross-correlation map may include, for example, determining, for each cross-correlation, a lag of the cross-correlation. The cross-correlation map may be generated by further mapping the cross-correlations as a function of the determined lags. The cross-correlation map comprises a mapping of the cross-correlations as a function of the channels as well as a function of the lags of the cross-correlations, as described in further detail below.

At block 312, based on the cross-correlation map, control module 15 (or a user) is able to identify potential zones of interest in the wellbore, by correlating relatively high cross-correlation strengths to a particular channel or particular channels of optical fiber 12.

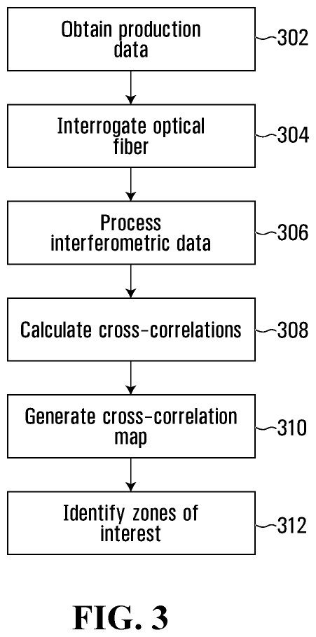

The general process shown in FIG. 3 will now be described in further detail, with reference to specific examples now shown and described in connection with FIGS. 4-18C. According to some of the embodiments discussed below, optical fiber with FBGs providing a spatial resolution (i.e. channel length) of 12.5 meters, with 240 channels in total, was used.

Referring to FIG. 4, there is shown an example plot of production data, showing flowrate (on the right-hand side vertical axis) of condensate as a function of time. The plot additionally depicts RMS magnitude of acoustic data (on the left-hand side vertical axis, in radians) as a function of time. The acoustic data was obtained by interrogating optical fiber alongside the wellbore, as described above.

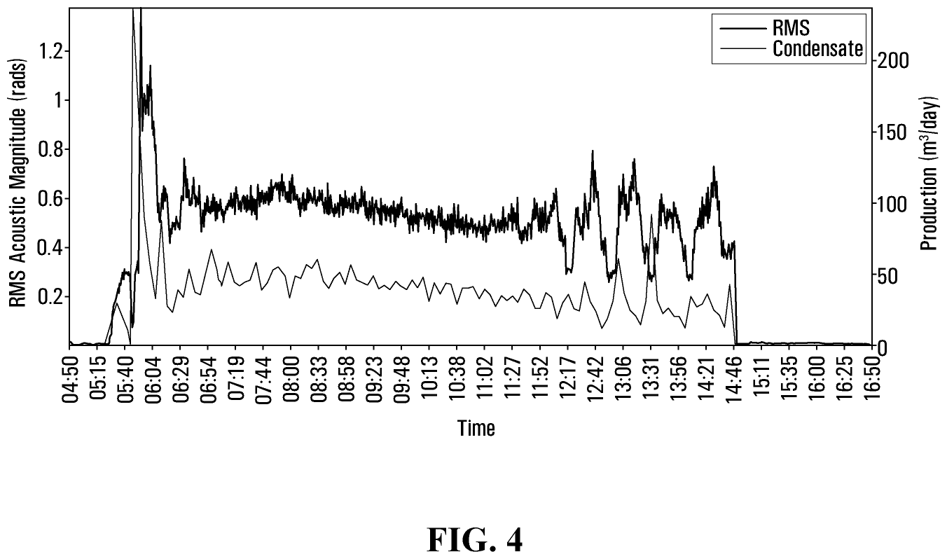

Referring to FIG. 5, there is shown an example plot of production data, showing flowrate (on the right-hand side vertical axis) of condensate as a function of time. The plot additionally depicts differential temperature data (on the left-hand side vertical axis, in radians) as a function of time. The differential temperature data was obtained by interrogating optical fiber alongside the wellbore, as described above.

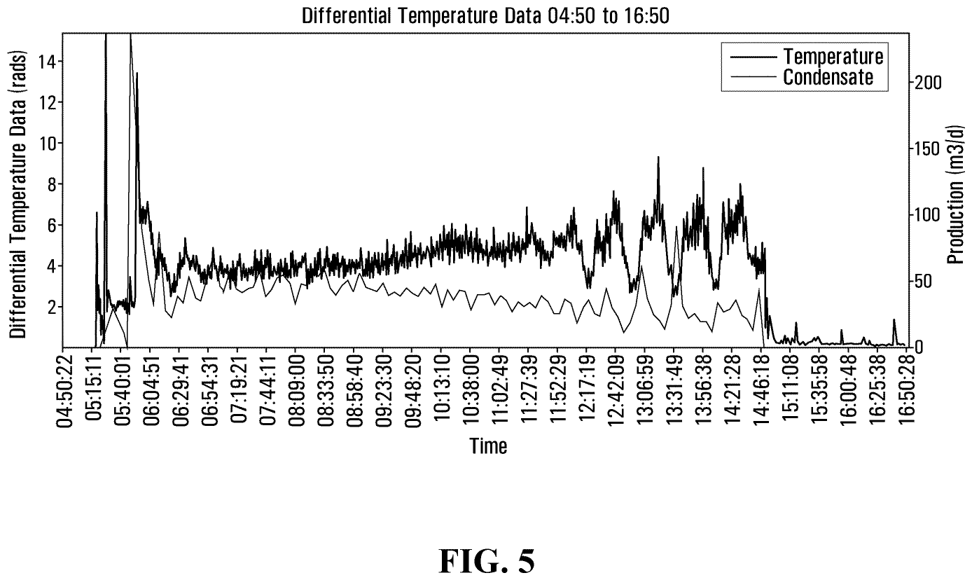

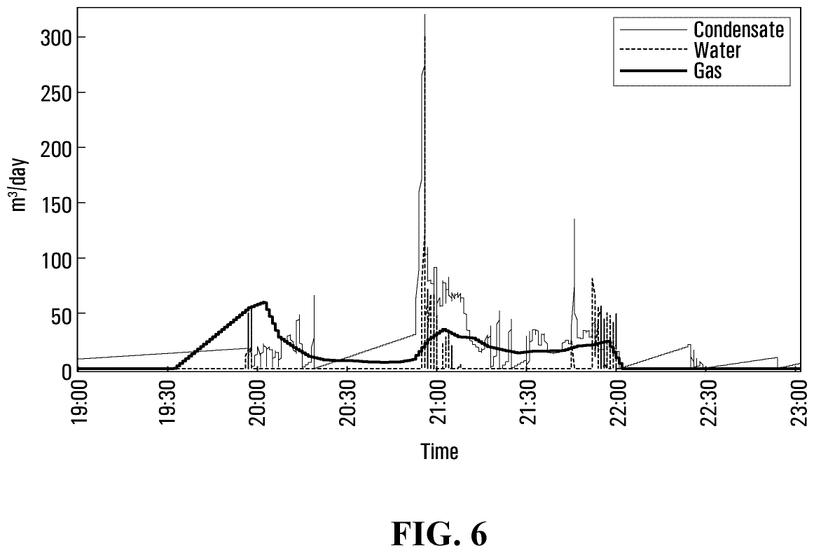

Referring to FIG. 6, there is shown an example plot of production data, showing flowrate (m³/day) of various products (condensate, gas, and water) as a function of time. FIG. 7 shows a plot of spectral power density of the production data in FIG. 6. As can be seen, the flow generally has a frequency in the range of 20 Hz-150 Hz. Since the acoustic data generated from interrogation of the optical fiber generally has a wide frequency range of 1 Hz-8,000 Hz, preprocessing of the acoustic data is needed.

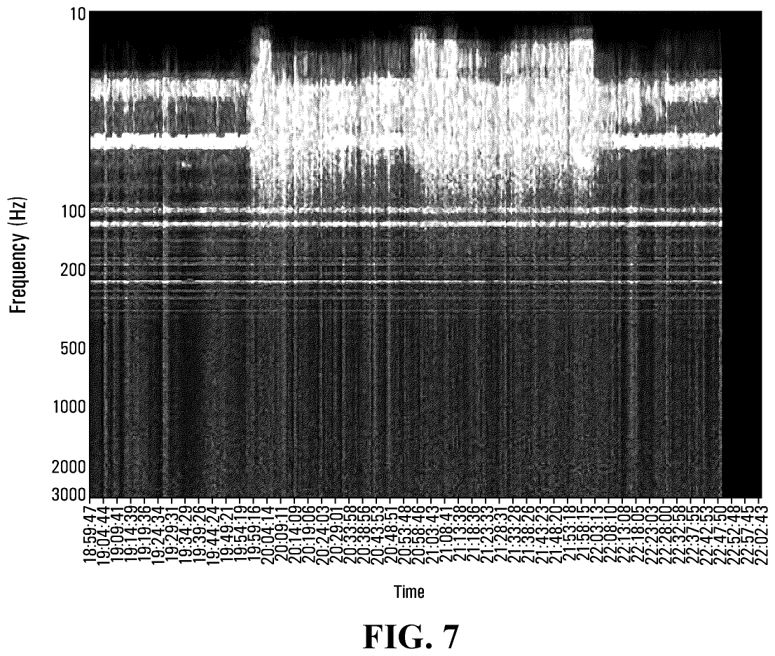

As can be seen in FIG. 8, there is shown a plot of the acoustic data obtained from interrogation of the optical fiber but with a DC offset removed (e.g. subtracting the first data point from the signal).

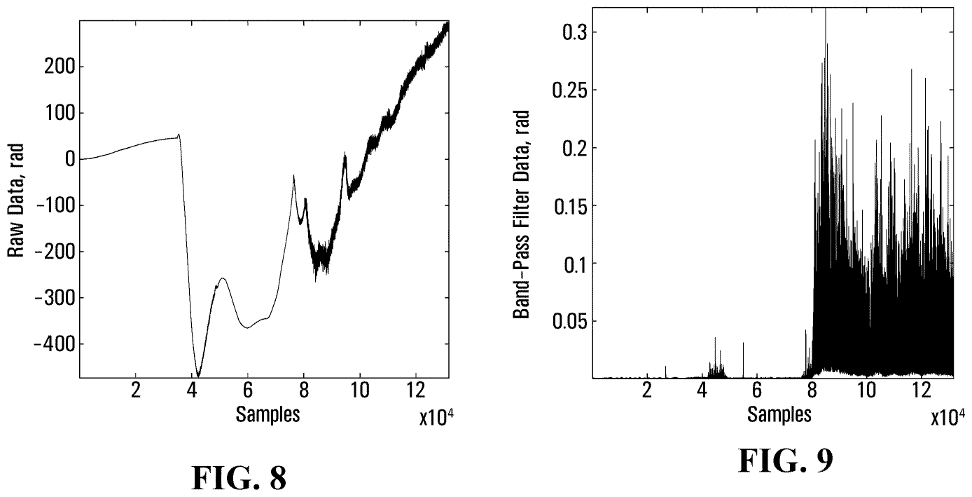

In FIG. 9, the data from FIG. 8 is passed through a band-pass filter to remove data outside of the 20 Hz-100 Hz range, as defined by the production data in FIG. 7.

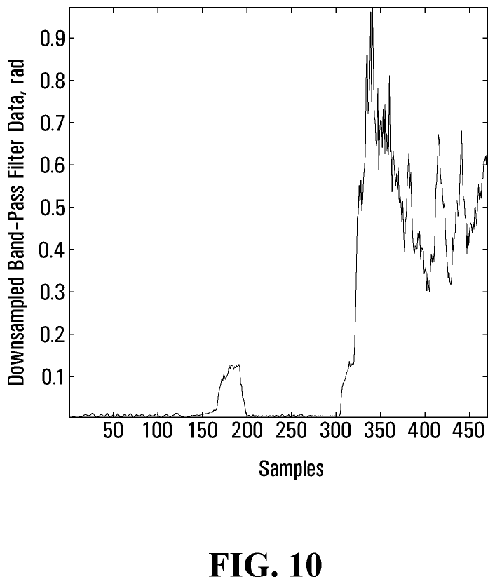

In FIG. 10, the data from FIG. 9 is down-sampled such that its sampling rate corresponds to that of the production data in FIG. 6.

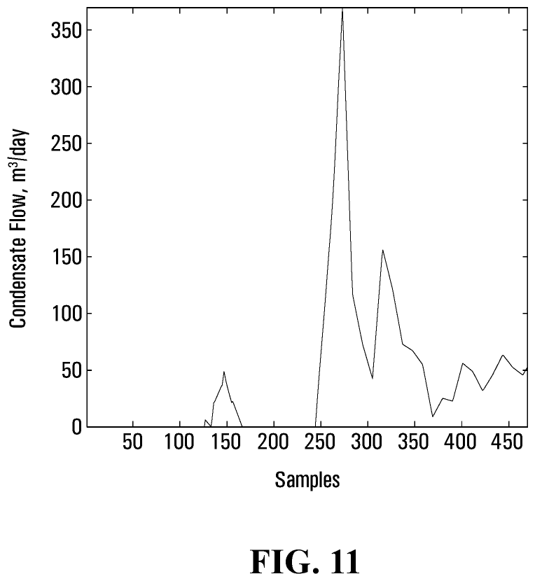

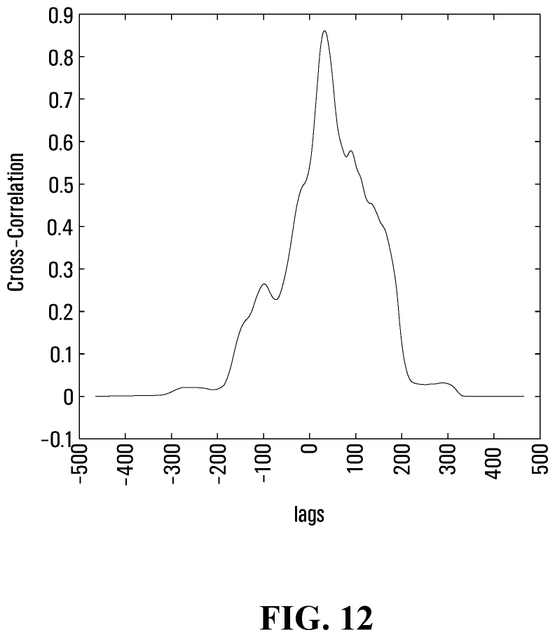

Turning to FIG. 11, there is shown another plot of condensate flowrate as a function of time. FIG. 12 then shows the result of the cross-correlation of the production data in FIG. 11 with the preprocessed acoustic data in FIG. 10 for a single channel (in this case, channel 171). The means of both the production data and the preprocessed acoustic data were subtracted from their respective signals to eliminate any triangular offset, and the sequences were normalized so that the maximum cross-correlation is 1.

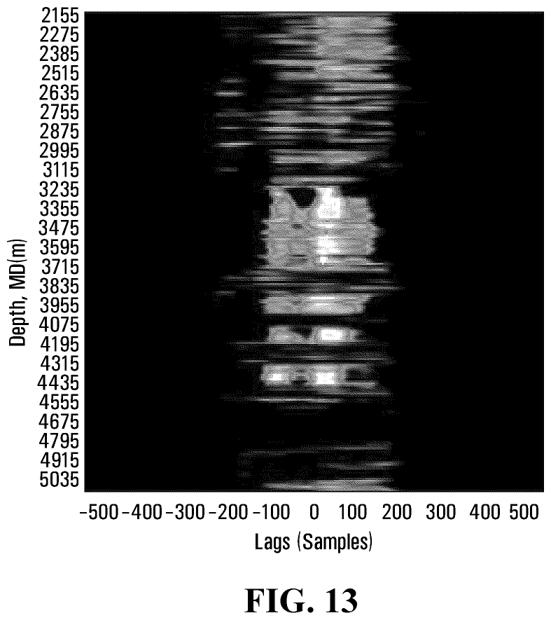

The cross-correlation plot shown in FIG. 12 is for a single channel of the optical fiber. By repeating the cross-correlation calculation for each channel of the optical fiber, a cross-correlation map is generated as can be seen in FIG. 13. The brighter areas of FIG. 13 represent higher cross-correlation strengths, whereas the darker areas of FIG. 13 represent lower cross-correlation strengths, as a function of depth of the wellbore (i.e. as a function of channel of the optical fiber) and lag of the cross-correlations.

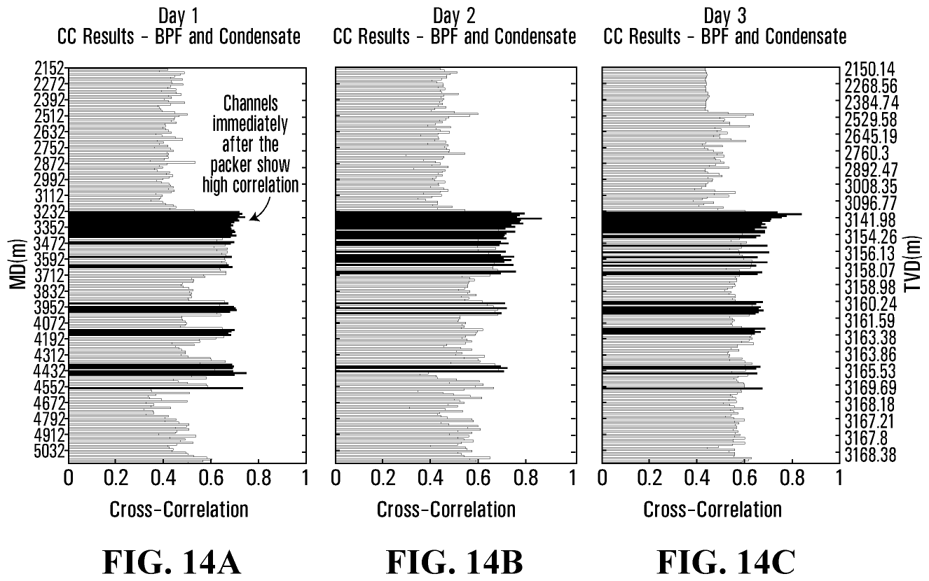

FIGS. 14A-14C show plots of cross-correlation maps for different sets of production data obtained on different days. The dark bars indicate regions of relatively high cross-correlation strength. These dark bars therefore indicate areas of interest where production is highest. The cross-correlation maps of FIGS. 14A-14C are similar to the cross-correlation map of FIGS. 13, except that the x-axis is representative of cross-correlation strength, and the y-axis is representative of depth of the wellbore. In order to generate the plots in FIGS. 14A-14C from the one in FIG. 13, the cross-correlation strengths from FIG. 13 are integrated across the x-axis to produce a single number representing the strength of the cross-correlation at that depth. These numbers (one for each depth) form the bars in the plots of FIGS. 14A-14C. Alternatively, the maximum cross-correlation strength value at each depth may be chosen as the number representing the cross-correlation strength at that depth.

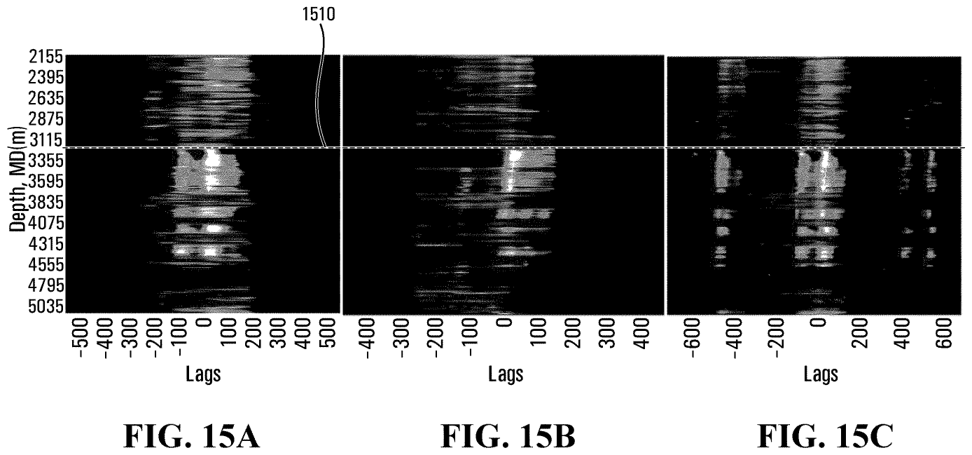

FIGS. 15A-15C show cross-correlation maps corresponding to the data in FIGS. 14A-14C. The position of a packer within the wellbore is shown by line 1510. As can be seen, the channels immediately after the packer are indicative of higher correlation strengths and therefore higher production rates.

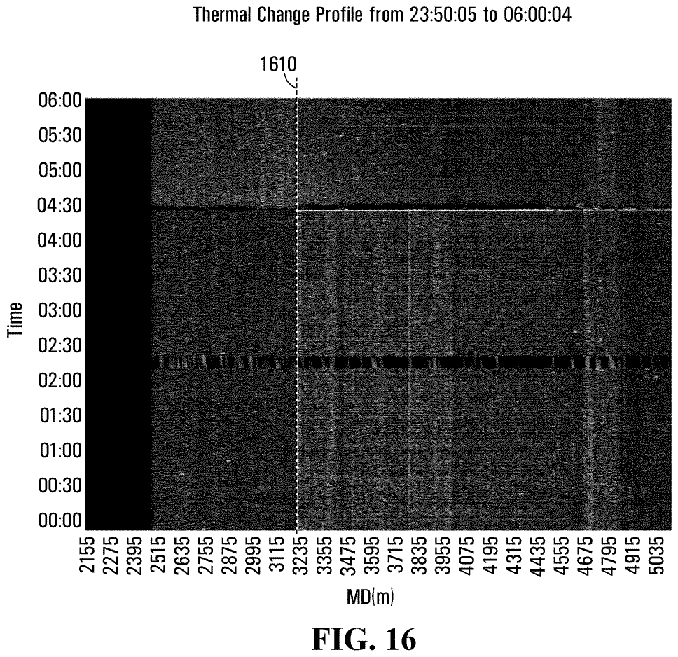

Turning now to FIG. 16 there is shown a plot of differential temperature data (obtained through interrogation of optical fiber, as described above) as a function of depth (y-axis) and time (x-axis). The position of a packer within the wellbore is shown by line 1610. As can be seen, the differential temperature data shows a higher magnitude for channels that immediately follow the packer, which may be indicative of a higher production rate below the packer.

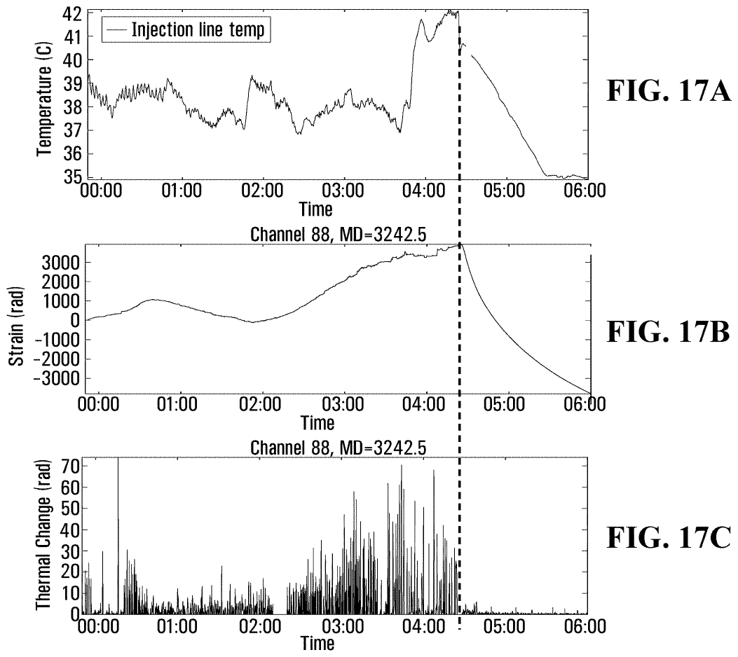

This data is borne out of by the further plots shown in FIGS. 17A-17C. In FIG. 17A, injection line temperature obtained using means other than optical fiber is shown plotted as a function of time. These temperature measurements are independent of any temperature/strain measurements obtained using optical fiber as described above. FIG. 17B shows strain measured using optical fiber as described above. FIG. 17C shows differential pressure as a function of time, the differential pressure being calculated based on the strain profile shown in FIG. 17B. As can be seen, the strain profile shown in FIG. 17B broadly correlates with the temperature profile shown in FIG. 17A. In FIGS. 17A-17C, the dotted line represents the point in time at which the measured temperature begins to drop sharply.

Therefore, zones of interest that are identified by means of the cross-correlation process described above may be confirmed as being zones of interest using temperature-based measurements. For example, a zone of interest that is identified based on its associated acoustic data correlating to production data (using the cross-correlation process described above) may be further assessed using temperature data from this zone. For instance, strain/temperature measurements obtained using optical fiber located at this zone may also be expected to correlate with the production data, since zones of relatively high production are generally expected to generate higher thermal change signatures. Therefore, temperature data may be used as a double-check to confirm the correlation between acoustic data and production data for particular zones of interest.

The embodiments have been described above with reference to flowcharts and block diagrams of methods, apparatuses, systems, and computer program products. In this regard, the flowcharts and block diagrams in the figures illustrate the architecture, functionality, and operation of possible implementations of various embodiments. For instance, each block of the flowcharts and block diagrams may represent a module, segment, or portion of code, which comprises one or more executable instructions for implementing the specified logical function(s). In some alternative embodiments, the functions noted in that block may occur out of the order noted in those figures. For example, two blocks shown in succession may, in some embodiments, be executed substantially concurrently, or the blocks may sometimes be executed in the reverse order, depending upon the functionality involved. Some specific examples of the foregoing have been noted above but those noted examples are not necessarily the only examples. Each block of the block diagrams and flowcharts, and combinations of those blocks, may be implemented by special purpose hardware-based systems that perform the specified functions or acts, or combinations of special purpose hardware and computer instructions.

Each block of the flowcharts and block diagrams and combinations thereof can be implemented by computer program instructions. These computer program instructions may be provided to a processor of a general-purpose computer, special-purpose computer, or other programmable data processing apparatus to produce a machine, such that the instructions, which execute via the processor of the computer or other programmable data-processing apparatus, create means for implementing the functions or acts specified in the blocks of the flowcharts and block diagrams.

These computer program instructions may also be stored in a computer-readable medium that can direct a computer, other programmable data-processing apparatus, or other devices to function in a particular manner, such that the instructions stored in the computer-readable medium produce an article of manufacture including instructions that implement the function or act specified in the blocks of the flowcharts and block diagrams. The computer program instructions may also be loaded onto a computer, other programmable data-processing apparatus, or other devices to cause a series of operational steps to be performed on the computer, other programmable apparatus or other devices to produce a computer-implemented process such that the instructions that execute on the computer or other programmable apparatus provide processes for implementing the functions or acts specified in the blocks of the flowcharts and block diagrams.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via an electrical element, electrical signal or a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

While the disclosure has been described in connection with specific embodiments, it is to be understood that the disclosure is not limited to these embodiments, and that alterations, modifications, and variations of these embodiments may be carried out by the skilled person without departing from the scope of the disclosure. It is furthermore contemplated that any part of any aspect or embodiment discussed in this specification can be implemented or combined with any part of any other aspect or embodiment discussed in this specification.

1. A method of identifying a zone of interest in a wellbore, the method comprising:
performing by one or more computer processors:
obtaining production data comprising data relating to surface production from the wellbore;
obtaining parameter data comprising data relating to one or more parameters of the wellbore as a function of depth along the wellbore; and
generating cross-correlation data by cross-correlating the production data with the parameter data, wherein the cross-correlation data comprises data relating to cross-correlation strength as a function of the depth along the wellbore; and
identifying within the cross-correlation data one or more zones of interest, based on the cross-correlation strength and the depth along the wellbore.

2. The method of claim 1, wherein obtaining the parameter data comprises generating the parameter data by:
using one or more sensors positioned along the wellbore to monitor the one or more parameters; and
generating the parameter data based on the monitored one or more parameters.

3. The method of claim 2, wherein:
the one or more sensors comprise one or more lengths of optical fiber; and
generating the parameter data comprises interrogating the one or more lengths of optical fiber using an optical fiber interrogator configured to transmit one or more light pulses along the one or more lengths of optical fiber and detect reflections of the one or more light pulses.

4. The method of claim 3, wherein the one or more lengths of optical fiber comprise one or more fiber Bragg gratings for reflecting the one or more lights pulses transmitted by the optical fiber interrogator.

5. The method of claim 3, wherein generating the parameter data comprises:
generating interferometric data by interrogating the one or more lengths of optical fiber using the optical fiber interrogator; and
extracting the parameter data by processing the interferometric data.

6. The method of claim 5, wherein extracting the parameter data comprises extracting acoustic data in a frequency range of 10 Hz-100,000 Hz from the interferometric data.

7. The method of claim 5, wherein extracting the data comprises extracting differential temperature or strain data in a frequency range of 0.001 Hz-10 Hz from the interferometric data.

8. The method of claim 1, wherein the one or more parameters comprise one or more of:
acoustics originating from the wellbore; and
differential temperature experienced by a sensor used to monitor the wellbore.

9. The method of claim 1, wherein obtaining the parameter data comprises:
receiving unfiltered parameter data; and
performing one or more of the following on the unfiltered parameter data:
filtering the unfiltered parameter data based on one or more frequency ranges; and
downsampling the unfiltered parameter data based on a sampling rate of the production data.

10. The method of claim 1, wherein:
obtaining the parameter data comprises generating the parameter data by interrogating optical fiber positioned alongside the wellbore, the optical fiber divided into multiple channels, each channel comprising a portion of a length of the optical fiber and being associated with a respective portion of the parameter data; and
generating the cross-correlation data comprises:
for each channel, cross-correlating the production data with the portion of the parameter associated with the channel.

11. The method of claim 1, wherein identifying the one or more zones of interests comprises:
identifying in the cross-correlation data one or more regions of relatively high cross-correlation strength; and
identifying the one or more zones of interests based on the one or more depths corresponding to the one or more regions of relatively high cross-correlation strength.

12. The method of claim 1, further comprising:
obtaining temperature data indicative of temperature as a function of the depth along the wellbore; and
confirming, based on the temperature data, at least one zone of interest of the one or more zones of interest as a zone of interest.

13. The method of claim 12, wherein confirming the zone of interest comprises:
comparing temperature data to the cross-correlation data; and
confirming, based on the comparison, the zone of interest.

14. The method of claim 12, wherein obtaining the temperature data comprises using one or more sensors positioned along the wellbore to generate the temperature data.

15. A system for monitoring a wellbore, comprising:
optical fiber positioned alongside the wellbore;
an optical fiber interrogator configured to interrogate the optical fiber; and
one or more computer processors configured to:
control the optical fiber interrogator so as to interrogate the optical fiber;
receive, based on the interrogation of the optical fiber, interferometric data from the optical fiber interrogator;
extract parameter data from the interferometric data, the parameter data comprising data relating to one or more parameters of the wellbore as a function of depth along the wellbore;
receive production data comprising data relating to surface production from the wellbore; and
generate cross-correlation data by cross-correlating the production data with the parameter data, wherein the cross-correlation data comprises data relating to cross-correlation strength as a function of the depth along the wellbore.

16. The system of claim 15, wherein the optical fiber comprises one or more fiber Bragg gratings for reflecting one or more lights pulses transmitted by the optical fiber interrogator.

17. The system of claim 15, wherein the one or more parameters comprise one or more of:
acoustics originating from the wellbore; and
differential temperature experienced by the optical fiber.

18. The system of claim 15, wherein the one or more computer processors are further configured to extract the parameter data by:
extracting unfiltered parameter data; and
performing one or more of the following on the extracted parameter data:
filtering the unfiltered parameter data based on one or more frequency ranges; and
downsampling the unfiltered parameter data based on a sampling rate of the production data.

19. The system of claim 15, wherein the one or more computer processors are further configured to:
interrogate each of multiple channels of the optical fiber, each channel comprising a portion of a length of the optical fiber;
for each channel, extract a portion of the parameter data; and
generate the cross-correlation data by:
for each channel, cross-correlating the production data with the portion of the parameter associated with the channel.

20. The system of claim 15, wherein the one or more computer processors are further configured to identify one or more zones of interest by:
identifying in the cross-correlation data one or more regions of relatively high cross-correlation strength; and
identifying the one or more zones of interests based on the one or more depths corresponding to the one or more regions of relatively high cross-correlation strength.

21. A non-transitory, computer-readable medium having stored thereon computer program code executable by one or more processors and configured, when executed by the one or more processors, to cause the one or more processors to perform a method of identifying a zone of interest in a wellbore, the method comprising:
receiving production data comprising data relating to surface production from the wellbore;
receiving parameter data comprising data relating to one or more parameters of the wellbore as a function of depth along the wellbore;
generating cross-correlation data by cross-correlating the production data with the parameter data, wherein the cross-correlation data comprises data relating to cross-correlation strength as a function of the depth along the wellbore; and
identifying within the cross-correlation data one or more zones of interest, based on the cross-correlation strength and the depth along the wellbore.
